(19) United States
(12) Patent Application Publication
(10) Pub. No.: US 2018/0281508 A1
(43) Pub. Date: Oct. 4, 2018

(54) ALUMINUM STRUCTURE HAVING WOOD GRAIN PATTERN AND METHOD FOR MANUFACTURING THEREOF

(71) Applicant: Sunlord Leisure Products, Inc., Rancho Cucamonga, CA (US)

(72) Inventor: Ai Ping LUO, Yorba Linda, CA (US)

(21) Appl. No.: 15/474,461

(22) Filed: Mar. 30, 2017

(51) Int. Cl. B44C 1/22; C23F 1/02; B05D 5/06; B44F 9/02

(52) U.S. Cl. CPC B44C 1/227; B44F 9/02; B05D 5/06; C23F 1/02

(57) ABSTRACT

Disclosed is a method for manufacturing an aluminum structure having wood grain pattern is disclosed. The method includes cleaning a surface of the aluminum structure, imprinting a wood grain pattern on the cleaned surface of the aluminum structure, immersing the printed aluminum structure in an acidic solution to form an etched wood grain pattern along the imprinted wood grain pattern. The method further includes coating the surface along with the etched wood grain pattern with a polymeric powder and heating the polymeric powder coating on the surface of the aluminum structure. Thereafter, the method includes applying a heat transfer ink paper on a layer of heated polymeric powder coating, and heating the heat transfer ink paper for diffusing ink from the ink paper into at least a portion of the layer of heated polymeric powder coating to form the aluminum structure with wood grain pattern.

### TECHNICAL FIELD

The present disclosure relates generally to faux or artificial wood finishes and, more particularly to, an aluminum structure having wood grain pattern and a method for manufacturing such aluminum structure.

### BACKGROUND

Natural wood is mostly used in housing and furniture industries, as natural wood is highly desirable for making certain products due to its richness. However, this requires cutting of trees to meet ever increasing demand for the natural wood. Further, natural wood is susceptible to discoloration, splitting and other effects caused by the outdoor environment. Also, use of such natural wood is expensive and not suitable from environmental aspect.

Conventionally, there are faux or artificial wood finishes know in the art that act as alternate of the natural wood. For example, plastic and ceramic wood are well known in the art, however such artificial wood finishes are not resistant to weather. Such artificial wood are also of limited size, heavy weight, easy to break, and difficult to process. Specifically, the plastic wood, for example, faux wood tiles made of plastic are generally small in size and are not suitable for outdoor purposes. Further, the ceramic wood, for example, faux wood tiles made of ceramic are also limited in size, easy to break, and heavy. Furthermore, the high pressure laminates are associated with shallow wood grain pattern and do not look real, in addition to being heavy, expensive and difficult to process. Moreover, the wood resin is limited in sizes and wood grains pattern thereof looks unreal.

In light of the foregoing discussion, there exists a need to overcome the aforementioned drawbacks of conventional faux or other artificial wood finishes.

### SUMMARY

Various embodiments of the present disclosure provide an aluminum structure having wood grain pattern and methods for manufacturing the aluminum structure having wood grain pattern.

In an embodiment, a method for manufacturing an aluminum structure having wood grain pattern is disclosed. The method comprises cleaning a surface of the aluminum structure, imprinting a wood grain pattern on the cleaned surface of the aluminum structure, immersing the printed aluminum structure in an acidic solution to form an etched wood grain pattern along the imprinted wood grain pattern, coating the surface along with the etched wood grain pattern with a polymeric powder, heating the polymeric powder coating on the surface of the aluminum structure, applying a heat transfer ink paper on a layer of heated polymeric powder coating, and heating the heat transfer ink paper for diffusing ink from the heat transfer ink paper into at least a portion of the layer of heated polymeric powder coating to form the aluminum structure with wood grain pattern.

In an embodiment, a method for manufacturing an aluminum structure having wood grain pattern is disclosed. The method comprises cleaning a surface of the aluminum structure, imprinting a wood grain pattern on the cleaned surface of the aluminum structure, immersing the printed aluminum structure in an acidic solution, comprising composition of 10-15% Iron III Chloride solution with 2% muriatic acid, to form an etched wood grain pattern along the imprinted wood grain pattern, cleaning the aluminum structure with the etched wood grain pattern with alkaline solution and water, coating the surface along with the etched wood grain pattern with a polymeric powder, comprising composition of 50% Polyester and 50% Polyurethane, heating the polymeric powder coating on the surface of the aluminum structure, applying a heat transfer ink paper on a layer of heated polymeric powder coating, and heating the heat transfer ink paper for diffusing ink from the heat transfer ink paper into at least a portion of the layer of heated polymeric powder coating to form the aluminum structure with wood grain pattern.

In an embodiment, an aluminum structure having wood grain pattern is disclosed. The aluminum structure comprises an outer surface, an etched wood grain pattern configured on the outer surface, and a coating of a polymeric powder on the outer surface and the etched wood grain pattern. At least a portion of the coating is diffused with an ink.

Other aspects and example embodiments are provided in the drawings and the detailed description that follows.

### BRIEF DESCRIPTION OF THE DRAWINGS

For a more complete understanding of example embodiments of the present technology, reference is now made to the following descriptions taken in connection with the accompanying drawings in which:

FIGS. 1-3 are perspective views aluminum structures having wood grain pattern, in accordance with various example embodiments;

FIGS. 4-8 are schematic illustrations of various steps involved in imprinting wood grain pattern on a surface of an aluminum structure, in accordance with an example embodiment;

FIGS. 9-16 are schematic illustrations of various steps, involved in manufacturing an aluminum structure having wood grain pattern, subsequent to imprinting of the wood grain pattern as shown in FIGS. 4-8, in accordance with an example embodiment; and

FIG. 17 illustrates steps of a method for manufacturing an aluminum structure having wood grain pattern, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

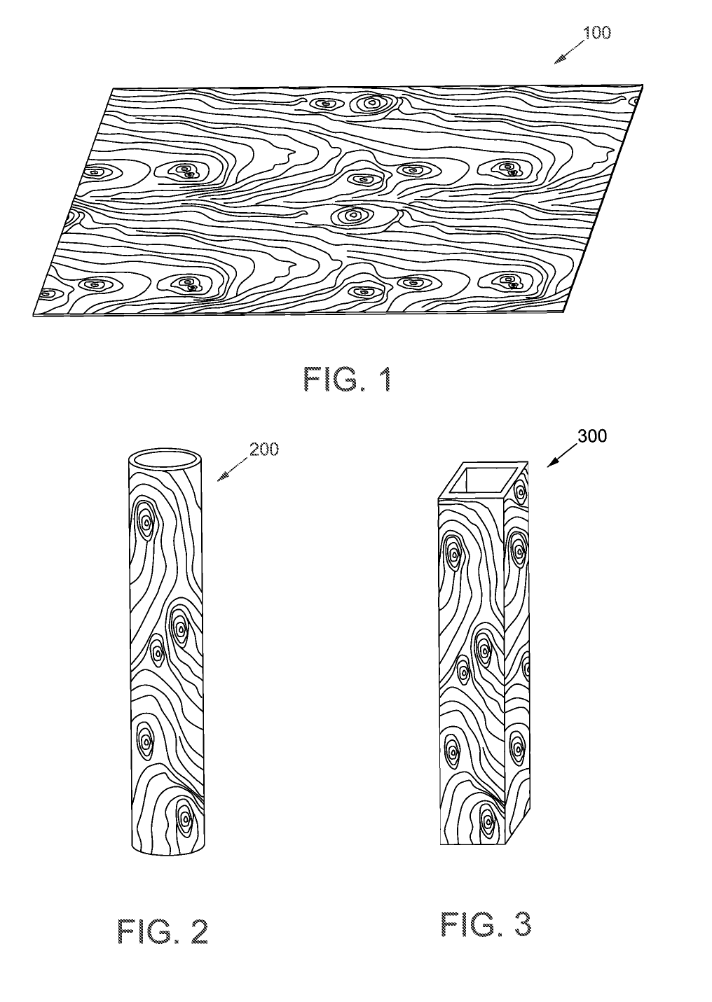

Referring now to the drawings, FIGS. 1-3 are perspective views of aluminum structures having wood grain pattern, in accordance with various example embodiments. As shown, FIGS. 1-3 depict aluminum structures 100, 200 and 300 (having wood grain pattern) that are a flat sheet, a cylindrical structure, and a cubical structure, respectively. Specifically, the aluminum structure 100 is an aluminum sheet having wood grain pattern thereon, the aluminum structure 200 is an aluminum tube having wood grain pattern thereon, and the aluminum structure 300 an aluminum hollow cubical rod having wood grain pattern thereon.

In one embodiment, a grade of aluminum material may be selected as, i.e. 1050 for an aluminum sheet (i.e. aluminum structure 100), and 6063 or 6061 for aluminum tubes (i.e. aluminum structures 200, 300, respectively). However, the present disclosure may not be limited to above mentioned alloys only, and various kinds of alloys can be used for providing faux or artificial wood effect.

Each of the aluminum structures 100, 200, 300 of the present disclosure includes an outer surface, an etched wood grain pattern configured on the outer surface, and a coating of a polymeric powder on the etched wood grain pattern diffused with an ink, which is explained in greater detail herein later in conjunction with subsequent figures. It is to be understood that, each of the aluminum structures 100, 200, 300 (i.e. flat sheet, cylindrical structure, cubical structure) may be a solid or a hollow structure and may include an inner surface, edge surfaces and so forth in addition to the outer surface. For example, the outer surface of the aluminum structures 100, 200, 300 includes an outer surface for the cylindrical and cubical aluminum structures 200, 300; and at least one of a top or a bottom surface for the aluminum flat sheet 100. Specifically, the aluminum structure 100 being a flat rectangular sheet primarily includes two opposite rectangular surfaces and edge surfaces, whereas the aluminum structures 200, 300 being hollow cylindrical and cubical structures, respectively, include opposite inner and outer surfaces and edge surfaces.

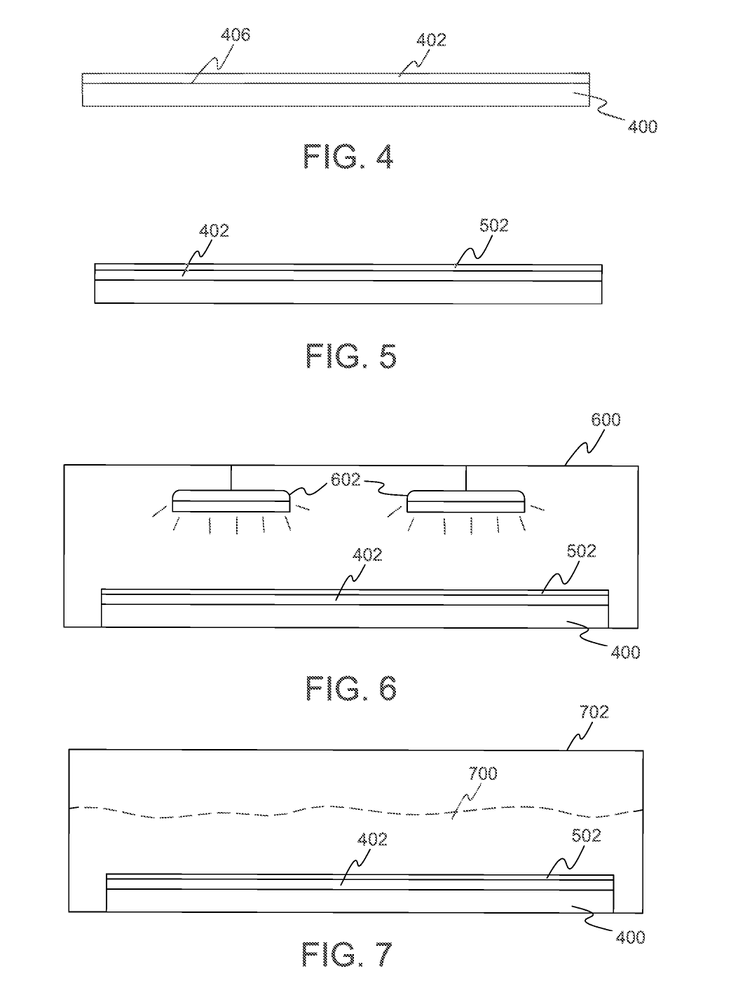

Referring now to FIGS. 4-8, illustrated are schematic illustrations of various steps involved in imprinting wood grain pattern on a surface of an aluminum structure, in accordance with an example embodiment. Specifically, FIGS. 4-8 are associated with imprinting of wood grain pattern on a surface of an aluminum structure, such as the aluminum structures 100. However, it is to be understood that aluminum structures 200, 300 may also follow similar steps as depicted in FIGS. 4-8 for imprinting wood grain pattern on an outer surface thereof.

As shown in FIG. 4, for imprinting the wood grain pattern (i.e. on a top rectangular outer surface) of an aluminum structure 400, a layer of a light reactive paint 402 is applied on a surface 406 of the aluminum structure 400. According to an embodiment, prior to applying the layer of paint 402 on the surface 406, the surface 406 is cleaned. Specifically, the surface 406 may be cleaned with the help of an alkaline solution to remove dirt and grease from the surface 406.

In one embodiment, as shown in FIG. 5, for imprinting the wood grain pattern on the layer of light reactive paint 402 is subjected to ultraviolet light, which causes areas of the layer of light reactive paint 402 exposed to the ultraviolet light to vanish (or react). Thus, the areas to be etched (which is explained in detail with subsequent figures) for imprinting the wood grain pattern on the surface 406 will be exposed to the ultraviolet light, while the rest of area of the surface 406 would be still covered by the layer of light reactive paint 402.

In one embodiment, the layer of light reactive paint 402 may be subject to the ultraviolet light in a specific manner such that specific areas of the layer of light reactive paint 402 get exposed to the ultraviolet light for reacting with paint of the specific exposed areas. This imprints a wood grain pattern on the surface 406. In an example, for imprinting the wood grain pattern, a thin film 502 having cutout pattern of any suitable or desired wood grain pattern (not shown) is glued to the painted surface. As shown, the film 502 is glued to the layer of light reactive paint 402. Referring now to FIG. 6, the aluminum structure 400 having the layer of paint 402 glued with the film 502 is inserted into a light chamber 600, and is subjected to light coming out of one or more light sources 602. It is to be understood that, the light sources 602 may be ultraviolet light sources (such as lamps) capable of providing ultraviolet light. Therefore, the ultraviolet light passes through the cutout pattern of the film 502, and the areas of the layer of light reactive paint 402 exposed to the ultraviolet light vanishes to form a wood grain pattern on the layer of light reactive paint 402.

Referring now to FIG. 7, the aluminum structure 400 with the layer of paint 402 (having the wood grain pattern imprinted thereon) and the glued film 502, are shown to be immersed in an acidic solution 700. Specifically, the aluminum structure 400 having the layer of paint 402 and the glued film 502 is inserted into a chamber 702, containing the acidic solution 700 therein. The acidic solution 700 allows removing of the glued film 502 and the reacted paint to form an imprinted wood grain pattern on the layer of paint 402. In an example, the acidic solution 700 includes hydrofluoric acid solution. Further, the aluminum structure 400 with the layer of paint 402 (having the wood grain pattern imprinted thereon) may be immersed in the acidic solution 700 for 5-10 seconds for removing of the glued film 502 and the reacted paint from the layer of paint 402.

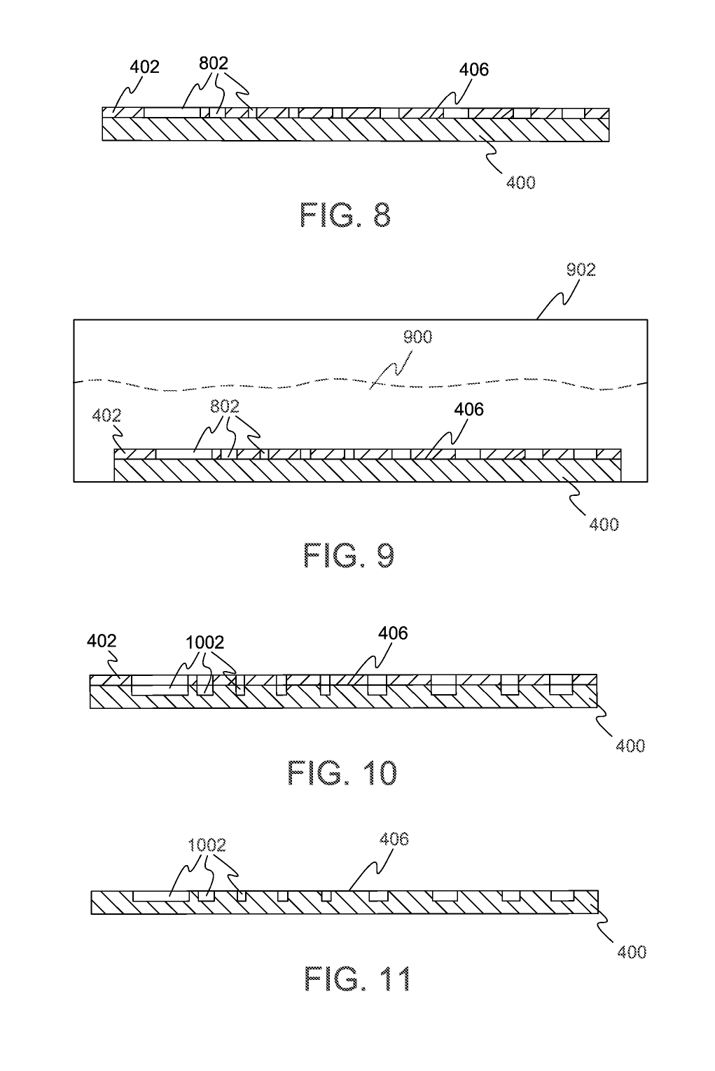

Referring now to FIG. 8, illustrated is a cross-sectional view of the aluminum structure 400 with the layer of paint 402 having an imprinted wood grain pattern thereon, in accordance with an example embodiment. As shown, the wood grain pattern on the layer of paint 402 is defined with the help of grooves 802 (or channels), which is formed when the layer of paint 402 (having the wood grain pattern imprinted thereon) is immersed in the acidic solution 700, as shown in FIG. 7. In another embodiment, a wood grain pattern (such as defined by the grooves 802) may be formed on the surface 406 of the aluminum structure 400 using a screen printing technique. Alternatively, such wood grain pattern may be imprinted on the surface 406 of the aluminum structure 400 by spray printing with the help of a film having cutout pattern resembling any suitable or desired wood grain pattern.

Referring now to FIGS. 9-16, illustrated are schematic illustrations of various steps, involved in manufacturing an aluminum structure (such as aluminum structures 100), subsequent to imprinting of the wood grain pattern as shown and explained in conjunction with FIGS. 4-8, in accordance with an example embodiment. As shown in FIG. 9, the printed aluminum structure, i.e. the aluminum structure 400 imprinted with the wood grain pattern (defined by the grooves 802), is immersed in an acidic solution 900 to form an etched wood grain pattern along the imprinted wood grain pattern (i.e. along the grooves 802). Specifically, the aluminum structure 400 with the layer of paint 402 (having the grooves 802) is immersed in a chamber 902 having the acidic solution 900. The acidic solution 900 composition may include 10-15% Iron III Chloride solution with 2% muriatic acid. Therefore, the wood grain pattern, defined by the grooves 802 on the layer of paint 402, exposes the surface 406 of the aluminum structure 400 to the an acidic solution 900, and accordingly the etched wood grain pattern forms on the surface 406 of the aluminum structure 400.

Referring now to FIG. 10, illustrated is a cross-sectional view of the aluminum structure 400 with the layer of paint 402 and the etched wood grain pattern formed on the surface 406 of the aluminum structure 400, in accordance with an example embodiment. Specifically, the etched wood grain pattern on the surface 406 of the aluminum structure 400 is defined by the grooves 1002. Further, referring now to FIG. 11, the layer of paint 402 (as shown in FIG. 10) is shown to be cleaned or removed from the surface 406 of the aluminum structure 400. In an example, the layer of paint 402 may be cleaned by cleaning the surface 406 with alkaline solution and water. This leaves the aluminum structure 400 with the grooves 1002 defining the etched wood grain pattern (defined by the grooves 1002) on the surface 406. In an example, a depth of the grooves 1002 defining the etched wood grain pattern on the surface 406 may be 0.2. millimeters. However, it is to be understood that the depth of the grooves 1002 may be deeper or shallower, compared to the above mentioned depth, depending on kind of wood gain patter to be formed on the aluminum structure 400.

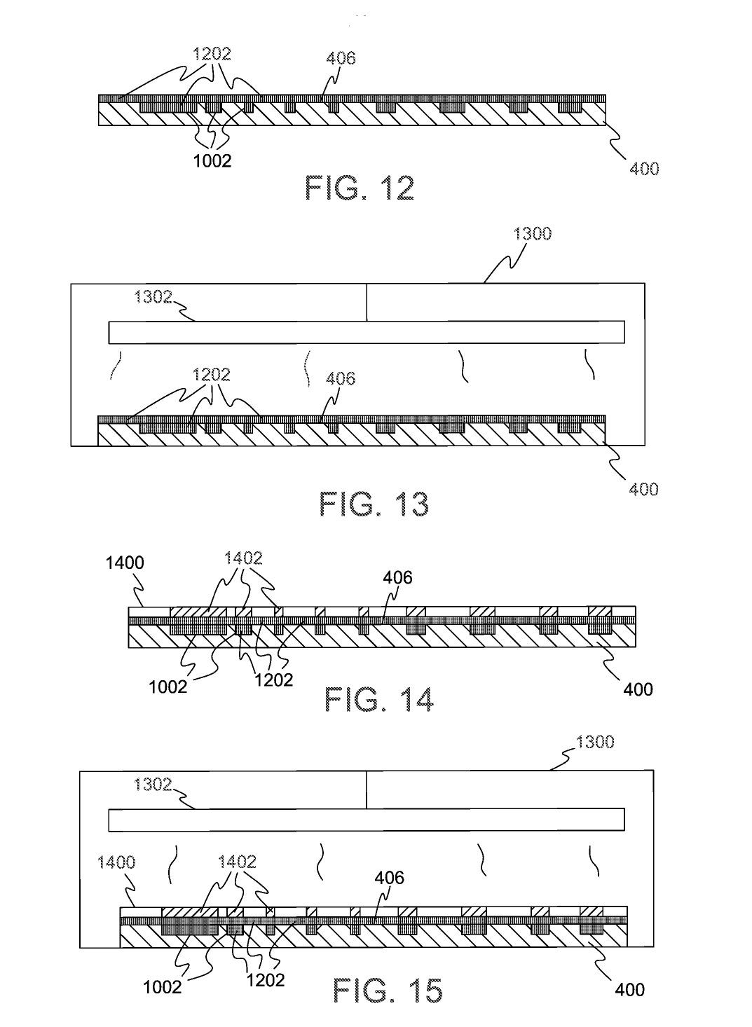

Referring now to FIG. 12, illustrated is a cross-sectional view of the aluminum structure 400 with the surface 406 coated with a polymeric powder, in accordance with an example embodiment. As shown, a layer of polymeric powder coating 1202 is applied on the entire surface 406 including the grooves 1002. It is to be understood that the surface 406 may be dried (after cleaning with the alkaline solution and water) prior to coating with the polymeric powder. In an example, the polymeric powder composition includes 50% Polyester and 50% Polyurethane. Thereafter, as shown in FIG. 13, the layer of polymeric powder coating 1202 is heated. As shown, the aluminum structure 400 with the layer of polymeric powder coating 1202 may be inserted in a chamber 1300 having a heating element 1302 for heating the layer of polymeric powder coating 1202. In an example, the layer of polymeric powder coating 1202 on the surface 406 of the aluminum structure 400 is heated in the chamber 1300 at about 300 to 450 degree Fahrenheit for about 15-20 minutes. This forms a layer of heated polymeric powder coating 1202 of about 1 millimeter thickness on the entire surface 406 including the grooves 1002.

Referring now to FIG. 14, illustrated is a cross-sectional view of the aluminum structure 400 with the layer of heated polymeric powder coating 1202, on the surface 406, applied with a heat transfer ink paper 1400. As shown, the heat transfer ink paper 1400 includes ink 1402 to be applied on the layer of heated polymeric powder coating 1202 (i.e. on areas of the layer of heated polymeric powder coating 1202 present in the grooves 1002). In other words, the paper 1400 includes the ink 1402 on such portions thereof that conforms to areas of depression (i.e. caused by the grooves 1002) on the layer of heated polymeric powder coating 1202, and not to upward projecting areas of the layer of heated polymeric powder coating 1202. In an example, the heat transfer ink paper 1400 may be made of a heat transferring ink and a paper having an ink pattern (conforming to the depression of the layer of heated polymeric powder coating 1202). Further, the ink pattern may be printed onto the paper 1400 through a printing mold.

Thereafter, as shown in FIG. 15, the ink paper 1400 is heated for diffusing the ink 1402 from the ink paper 1400 into at least a portion of the layer of heated polymeric powder coating 1202. As shown, the aluminum structure 400 with the heat transfer ink paper 1400 on the layer of heated polymeric powder coating 1202 is inserted in the chamber 1300 (having the heating element 1302) for heating the heat transfer ink paper 1400. The ink 1402 from the ink paper 1400 diffused into at least the portion of the layer of heated polymeric powder coating 1202 (particularly, the areas of the depressions, i.e. caused by the grooves 1002, in the layer of heated polymeric powder coating 1202 and not in upward projecting areas of the layer of heated polymeric powder coating 1202) to form the aluminum structure 400 having wood grain pattern. For example, the ink 1402 vaporizes once the heat transfer ink paper 1400 is subjected to high temperature of about 250-350 degrees Fahrenheit for about 8-15 minutes, and the ink 1402 diffuses or mixes with the areas of depressions of the layer of heated polymeric powder coating 1202 to create textures of wood grain pattern on the surface 406 of the aluminum structure 400.

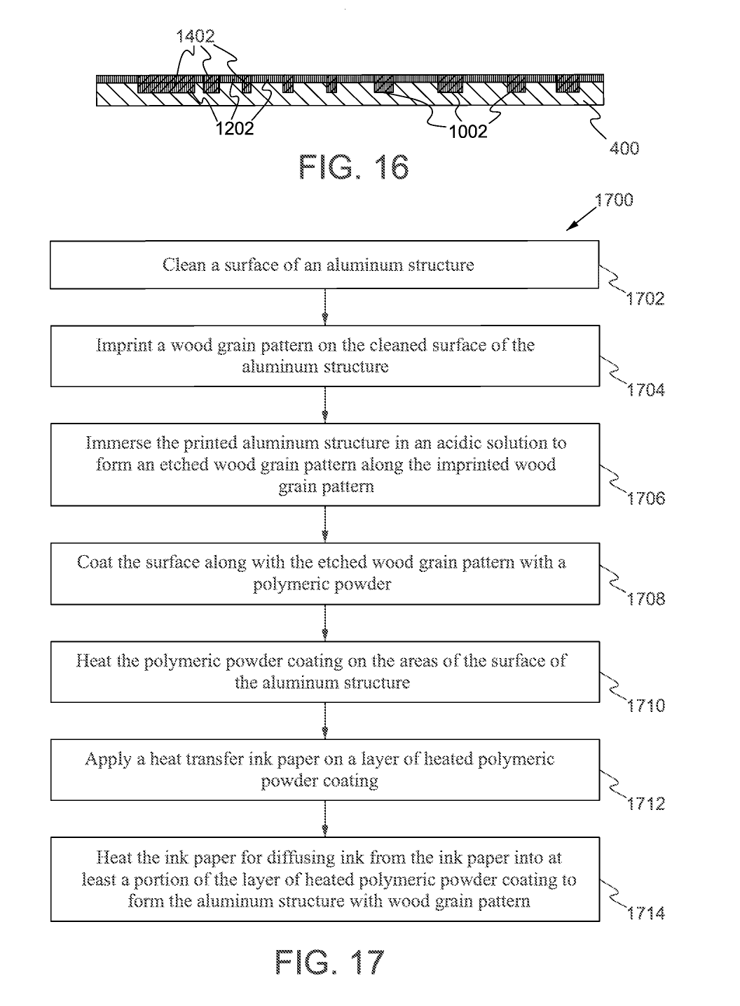

Referring now to FIG. 16, illustrated is a cross-sectional view of the aluminum structure 400, which is formed with the help of the layer of heated polymeric powder coating 1202 diffused with the ink 1402. Further, the ink paper 1400 (shown in FIG. 15) is removed from the layer of heated polymeric powder coating 1202. Furthermore, the etched grooves 1002 match a suitable or desired wood grain pattern to enable the aluminum structure 400 to be faux or artificial wood finishes. It is to be understood that the aluminum structure 400 having wood grain pattern (as shown in FIG. 16) may be the aluminum structure 100, shown in FIG. 1. Further, the aluminum structures 200, 300 may also follow the various steps depicted and explained in conjunction with the FIGS. 4-16 to form the aluminum structures 200, 300 having wood grain pattern, shown in FIGS. 2 and 3.

Referring to FIG. 17, illustrated are steps of a method 1700 for manufacturing an aluminum structure having wood grain pattern, in accordance with an embodiment of the present disclosure. Those skilled in the art would recognize that the method 1700 is associated with manufacturing an aluminum structure, such as the aluminum structures 100, 200, 300, explained herein above in conjunction with FIGS. 1-16.

At step 1702, a surface of an aluminum structure is cleaned.

At step 1704, a wood grain pattern is imprinted on the cleaned surface of the aluminum structure.

At step 1706, the printed aluminum structure is immersed in an acidic solution to form an etched wood grain pattern along the imprinted wood grain pattern.

At step 1708, the surface along with the etched wood grain pattern is coated with a polymeric powder.

At step 1710, the polymeric powder coating on the surface of the aluminum structure is heated.

At step 1712, a heat transfer ink paper is applied on a layer of heated polymeric powder coating.

At step 1714, the ink paper is heated for diffusing ink from the ink paper into at least a portion of the layer of heated polymeric powder coating.

The steps 1702 to 1714 are only illustrative and other alternatives can also be provided where one or more steps are added, one or more steps are removed, or one or more steps are provided in a different sequence without departing from the scope of the claims herein. For example, the method 1700 may further include cleaning the aluminum structure with the etched wood grain pattern with alkaline solution and water prior to coating the surface and the etched wood grain pattern with the polymeric powder. Further, in the method 1700, imprinting the wood grain pattern may be performed by a screen printing technique. Alternatively, imprinting the wood grain pattern may be performed by applying a layer of a light reactive paint on the cleaned surface of the aluminum structure; gluing a thin film having a wood grain pattern on the painted surface; subjecting the glued film to light for allowing imprinting of the wood grain pattern on the painted layer; and immersing the aluminum structure with the glued film in an acidic solution for removing the glued film and the reacted paint of the painted layer.

Embodiments of the present disclosure substantially eliminate or at least partially address the aforementioned problems in the background, and provide faux or artificial wood finishes, such as aluminum structure having wood grain pattern thereon. The aluminum structures of the present disclosure enable in replacing real wood products. Further, the aluminum structures of the present disclosure can be very thin and thus light weighted. This enables the aluminum structures to be easily processed i.e. bendable (or foldable) and cut to desire. The wood grain pattern on the aluminum structures look and feel more real. Therefore, the aluminum structures of the present disclosure can be suitably and efficiently used as replacement to wood, and as constriction material in housing and furniture industries. Finally, the aluminum structures of the present disclosure do not require maintenance, and eco-friendly and recyclable.

The embodiments illustrated and described herein as well as embodiments not specifically described herein but within the scope of aspects of the invention constitute exemplary faux or artificial wood finishes.

The benefits and advantages described above may relate to one embodiment or may relate to several embodiments. The embodiments are not limited to those that solve any or all of the stated problems or those that have any or all of the stated benefits and advantages.

The operations of the method described herein may be carried out in any suitable order, or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

The above description is given by way of example only and various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method for manufacturing an aluminum structure having wood grain pattern, the method comprising:
cleaning a surface of the aluminum structure;
imprinting a wood grain pattern on the cleaned surface of the aluminum structure;
immersing the printed aluminum structure in an acidic solution to form an etched wood grain pattern along the imprinted wood grain pattern;
coating the surface along with the etched wood grain pattern with a polymeric powder;
heating the polymeric powder coating on the surface of the aluminum structure;
applying a heat transfer ink paper on a layer of heated polymeric powder coating; and
heating the heat transfer ink paper for diffusing ink from the heat transfer ink paper into at least a portion of the layer of heated polymeric powder coating to form the aluminum structure with wood grain pattern.

2. The method as claimed in claim 1, further comprising cleaning the aluminum structure with the etched wood grain pattern with alkaline solution and water prior to coating the surface and the etched wood grain pattern with the polymeric powder.

3. The method as claimed in claim 1, wherein the aluminum structure is configured to be one of a flat sheet, a cylindrical structure, and a cubical structure.

4. The method as claimed in claim 3, wherein the surface of the aluminum structure comprises an outer surface of the cylindrical and cubical structures; and at least one of a top or a bottom surface of the flat sheet.

5. The method as claimed in claim 1, wherein the acidic solution composition comprises 10-15% Iron III Chloride solution with 2% muriatic acid.

6. The method as claimed in claim 1, wherein the polymeric powder composition comprises 50% Polyester and 50% Polyurethane.

7. The method as claimed in claim 1, wherein imprinting the wood grain pattern is performed by a screen printing technique.

8. The method as claimed in claim 1, wherein imprinting the wood grain pattern is performed by
applying a layer of a light reactive paint on the cleaned surface of the aluminum structure, gluing a thin film having a wood grain pattern on the painted surface;
subjecting the glued film to light for allowing imprinting of the wood grain pattern on the painted layer;
immersing the aluminum structure with the glued film in an acidic solution for removing the glued film and the reacted paint of the painted layer.

9. The method as claimed in claim 8, wherein the acidic solution comprises hydrofluoric acid solution.

10. An aluminum structure having wood grain pattern, the aluminum structure comprising:
an outer surface;
an etched wood grain pattern configured on the outer surface; and
a coating of a polymeric powder on the outer surface and the etched wood grain pattern, wherein at least a portion of the coating is diffused with an ink.

11. The aluminum structure as claimed in claim 10, wherein the aluminum structure is configured to be one of a flat sheet, a cylindrical structure, and a cubical structure.

12. The aluminum structure as claimed in claim 11, wherein the outer surface of the aluminum structure comprises an outer surface of the cylindrical and cubical structures; and at least one of a top or a bottom surface of the flat sheet.

13. The aluminum structure as claimed in claim 10, wherein the etched wood grain pattern is configured on the outer surface by:
cleaning the outer surface;
imprinting a wood grain pattern on the cleaned outer surface; and
immersing the printed aluminum structure in an acidic solution to form the etched wood grain pattern along the imprinted wood grain pattern.

14. The aluminum structure as claimed in claim 13, wherein the acidic solution composition comprises 10-15% Iron III Chloride solution with 2% muriatic acid.

15. The aluminum structure as claimed in claim 13, wherein the coating of the polymeric powder on the outer surface and the etched wood grain pattern is formed by:
coating the outer surface and the etched wood grain pattern with the polymeric powder;
heating the polymeric powder coating on the surface of the aluminum structure;
applying a heat transfer ink paper on a layer of heated polymeric powder coating; and
heating the heat transfer ink paper for diffusing ink from the ink paper into at least the portion of the heated polymeric powder coating.

16. The aluminum structure as claimed in claim 15, wherein the polymeric powder composition comprises 50% Polyester and 50% Polyurethane.

17. The aluminum structure as claimed in claim 13, wherein imprinting the wood grain pattern is performed by a screen printing technique.

18. The aluminum structure as claimed in claim 13, wherein imprinting the wood grain pattern is performed by
applying a light reactive paint on the cleaned outer surface of the aluminum structure,
gluing a thin film having a wood grain pattern on the painted surface;
subjecting the glued film to light for allowing imprinting of the wood grain pattern on the painted layer; and immersing the aluminum structure with the glued film in an acidic solution for removing the glued film and the reacted paint of the painted layer.

19. A method for manufacturing an aluminum structure having wood grain pattern, the method comprising:
cleaning a surface of the aluminum structure with an alkaline solution;
applying a layer of reactive paint on the cleaned surface of the aluminum structure;
gluing a film having cutout pattern of desired wood grain pattern on the layer of reactive paint;
subjecting the layer of reactive paint to ultraviolet light such that specific areas of the layer of reactive paint get exposed to the ultraviolet light for reacting with paint of those specific areas to make the reactive paint vanish from those specific areas leaving printed aluminium structure with wood grain pattern, wherein the specific areas comprise areas for which the ultraviolet light passes through the cutout pattern;
immersing the printed aluminium structure into hydrofluoric acid solution to remove glued film and the reactive paint from the layer;
immersing the printed aluminum structure in an acidic solution, comprising composition of 10-15% Iron III Chloride solution with 2% muriatic acid, to form an etched wood grain pattern along the imprinted wood grain pattern;
cleaning the aluminum structure with the etched wood grain pattern with alkaline solution and water;
coating the surface along with the etched wood grain pattern with a polymeric powder, comprising composition of 50% Polyester and 50% Polyurethane;
heating the polymeric powder coating on the surface of the aluminum structure;
applying a heat transfer ink paper on a layer of heated polymeric powder coating; and
heating the heat transfer ink paper for diffusing ink from the heat transfer ink paper into at least a portion of the layer of heated polymeric powder coating to form the aluminum structure with wood grain pattern.

20. A method for manufacturing an aluminum structure having wood grain pattern, the method comprising:
cleaning a surface of the aluminum structure with an alkaline solution;
gluing a film having cutout pattern of desired wood grain pattern on the layer of reactive paint;
imprinting a wood grain pattern on the aluminum structure using at least one of a screen printing technique or a spray printing technique;
immersing the printed aluminum structure in an acidic solution, comprising composition of 10-15% Iron III Chloride solution with 2% muriatic acid, to form an etched wood grain pattern along the imprinted wood grain pattern;
cleaning the aluminum structure with the etched wood grain pattern with alkaline solution and water;
coating the surface along with the etched wood grain pattern with a polymeric powder, comprising composition of 50% Polyester and 50% Polyurethane;
heating the polymeric powder coating on the surface of the aluminum structure;
applying a heat transfer ink paper on a layer of heated polymeric powder coating; and
heating the heat transfer ink paper for diffusing ink from the heat transfer ink paper into at least a portion of the layer of heated polymeric powder coating to form the aluminum structure with wood grain pattern.
